(19) United States
(12) Patent Application Publication
(10) Pub. No.: US 2022/0294563 A1
(43) Pub. Date: Sep. 15, 2022

(54) NODE DEVICE

(71) Applicant: KABUSHIKI KAISHA TOKAI RIKA DENKI SEISAKUSHO, Aichi (JP)

(72) Inventor: Kenichi TAKAHASHI, Aichi (JP)

(73) Assignee: KABUSHIKI KAISHA TOKAI RIKA DENKI SEISAKUSHO, Aichi (JP)

(21) Appl. No.: 17/607,990

(22) PCT Filed: Apr. 20, 2020
(86) PCT No.: PCT/JP2020/017069

§ 371 Date: Nov. 1, 2021

(30) Foreign Application Priority Data
May 10, 2019 (JP) 2019-089689

(51) Int. Cl. H04L 1/08

(52) U.S. Cl. CPC H04L 1/08

(57) ABSTRACT

A node device adapted to be connected to a network communication bus includes a communication interface and a processor. The processor is configured to cause the communication interface to transmit data to the network communication bus. In a case where the processor fails to transmit the data, the processor is configured to advance a retransmission timing at which the data is retransmitted.

### FIELD

The presently disclosed subject matter relates to a node device adapted to be coupled to a network communication bus.

### BACKGROUND

Japanese Patent Publication No. 2014-027510A discloses a configuration in which data communication is performed between a plurality of node devices connected via a network communication bus. In this configuration, data may be simultaneously transmitted from a plurality of node devices to the same destination node device. When a data transmission conflict occurs in this manner, the destination node device executes an arbitration processing so as to receive only the data transmitted from a single node device. Specifically, the priority information assigned to the data transmitted from each node device is used for mutual comparison. Only the data determined to be assigned with the highest priority as a result of the comparison is received by the destination node device.

The node device having transmitted the data that was failed to be arbitrated retransmits the same data at a next prescribed timing. When a conflict occurs between the retransmitted data and data transmitted from another node device, the data is subjected to an arbitration processing again. Depending on the priority assigned to the retransmitted data, there may be a case where a specific node device continues to fail to be arbitrated and the data is received by the destination node device with delay.

### SUMMARY

### Technical Problem

Accordingly, it is demanded to suppress a delay in receiving data transmitted from a specific node device.

### Solution to Problem

In order to meet the demand described above, an illustrative aspect of the presently disclosed subject matter provides a node device adapted to be connected to a network communication bus, comprising:

a communication interface; and

a processor configured to cause the communication interface to transmit data to the network communication bus,

wherein in a case where the processor fails to transmit the data, the processor is configured to advance a retransmission timing at which the data is retransmitted.

The node device is generally configured not to perform transmission when another node device has already initiated data transmission to the network communication bus. According to the configuration as described above, since the timing of retransmission of data that has failed to be transmitted from a specific node device is advanced, it is possible to enhance the possibility that retransmission of data from the specific node device has already been initiated when it comes the timing of transmission of a node device comes that is unchanged from the initial state. Accordingly, it is possible to suppress a delay in receiving data transmitted from a specific node device.

### BRIEF DESCRIPTION OF DRAWINGS

FIG. 1 illustrates a configuration of a node device according to an embodiment.

FIG. 2 illustrates a configuration of data to be communicated between the node devices of FIG. 1.

FIG. 3 illustrates operations of the node devices of FIG. 1.

FIG. 4 illustrates operations of the node devices of FIG. 1.

FIG. 5 illustrates operations of the node devices of FIG. 1.

FIG. 6 illustrates operations of the node devices of FIG. 1.

### DESCRIPTION OF EMBODIMENTS

Examples of embodiments will be described in detail below with reference to the accompanying drawings. In each of the drawings used in the following description, the scale is appropriately changed in order to make each element have a recognizable size.

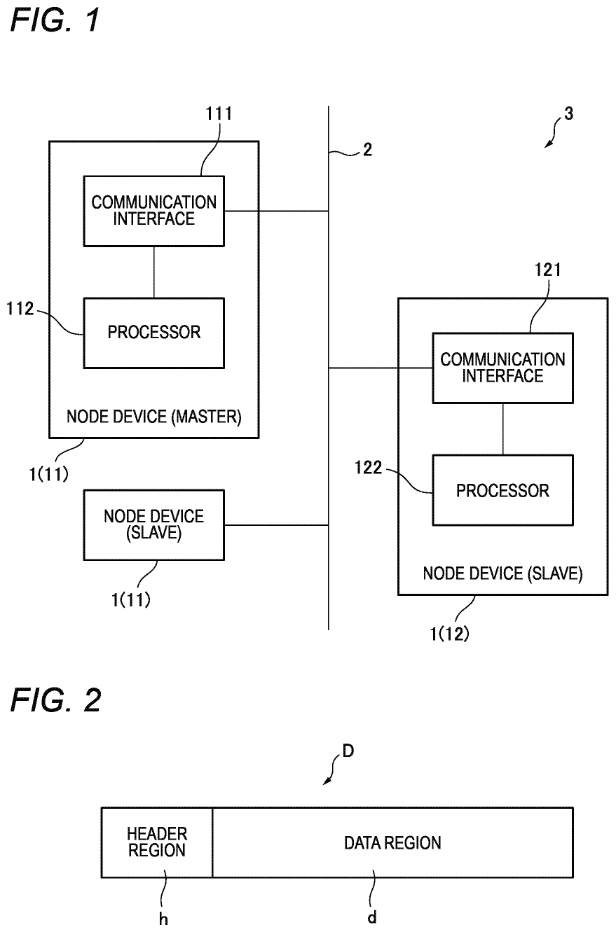

FIG. 1 illustrates a communication network 3 in which a plurality of node devices 1 are connected to a network communication bus 2. Each node device 1 is configured to be capable of communicating data D to each other via the network communication bus 2.

FIG. 2 illustrates a schematic configuration of the data D. The data D includes a header region h and a data region d. The header region h includes identification information for identifying the node device 1 as a sender and/or the content of the data, as well as priority information for indicating the relative priority levels of the node devices 1 in the communication network 3. The data region d includes main contents of the data to be communicated.

As an example, there will be described a configuration in which the communication network 3 is operated on the basis of a CXPI (Clock Extension Peripheral Interface) standard of a polling system. In this case, the node devices 1 include a master node device 11 and a slave node device 12. The master node device 11 may request the slave node device 12 to transmit the data D. The slave node device 12 may transmit the data D in response to the request.

Such a communication network 3 may be installed in a vehicle, for example. In this case, each node device 1 may be an ECU (Electronic Control Unit) for controlling the operation of an associated in-vehicle component. The master node device 11 may be an ECU for performing overall control in the vehicle. The slave node device 12 may be an ECU associated with a man-machine interface in the vehicle.

The master node device 11 includes a communication interface 111 and a processor 112. The processor 112 generates a clock signal. The clock signal is outputted to the network communication bus 2 via the communication interface 111. The clock signal is received by each slave node device 12 via the network communication bus 2. The clock signal is used for synchronizing various types of processing performed between the master node device 11 and each slave node device 12.

The processor 112 may be implemented by a general-purpose microprocessor operating in cooperation with a general-purpose memory. Examples of the general-purpose microprocessor include a CPU, an MPU, and a GPU. Examples of the general-purpose memory include a ROM and a RAM. In this case, a computer program capable of executing processing described later can be stored in the ROM. The processor 112 designates at least a part of the computer program stored in the ROM, loads the program on the RAM, and executes the processing described above in cooperation with the RAM. The processor 112 may be implemented by a dedicated integrated circuit such as a microcontroller, an ASIC, and an FPGA capable of executing a computer program for implementing processing described later. The processor 112 may be implemented by a combination of a general-purpose microprocessor and a dedicated integrated circuit.

The slave node device 12 includes a communication interface 121 and a processor 122. In response to a request from the master node device 11, the processor 122 causes the communication interface 121 to transmit the data D to the network communication bus 2. The processor 122 may be implemented by a dedicated integrated circuit such as a microcontroller, an ASIC, and an FPGA capable of executing a computer program for implementing processing described later.

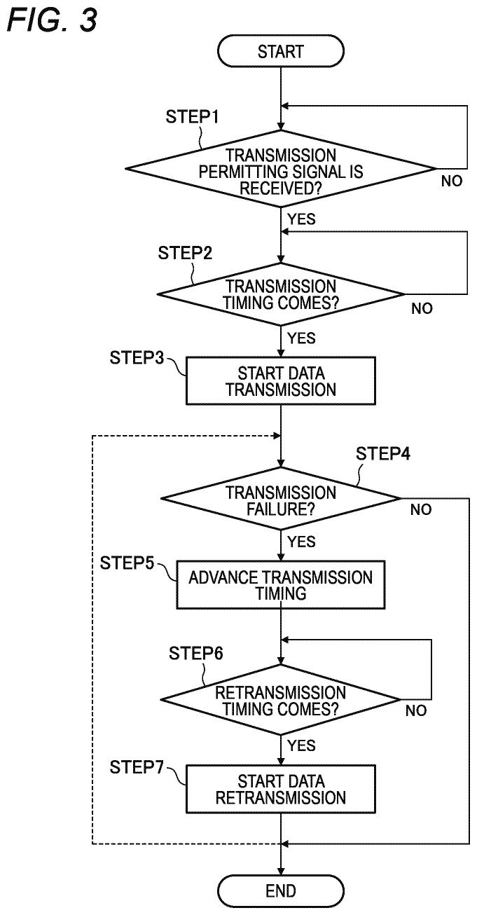

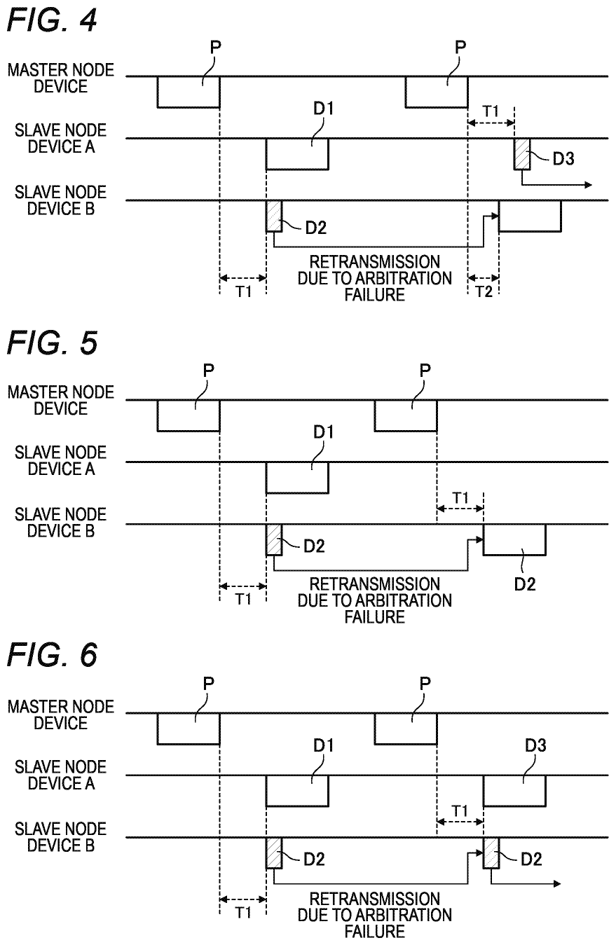

Referring to FIGS. 3 to 6, an example of processing executed by the processor 122 of each slave node device 12 will be described. As illustrated in FIG. 4, the master node device 11 is configured to be capable of transmitting a transmission permitting signal P for permitting all the slave node devices 12 to transmit data to the network communication bus 2. The transmission permitting signal P is generated by the processor 112 of the master node device 11, and is transmitted from the communication interface 111.

As illustrated in FIG. 3, the processor 122 of each slave node device 12 determines whether the communication interface 121 receives the transmission permitting signal P (STEP1). The determination is repeated until the transmission permitting signal P is received (NO in STEP1).

When it is determined that the transmission permitting signal P is received (YES in STEP1), the processor 122 determines whether a prescribed transmission timing comes (STEP2). As illustrated in FIG. 4, the transmission timing is defined based on a time length T1 after the transmission permitting signal P is received. In the initial state, the time length T1 is the same for all the slave node devices 12.

The time length T1 is determined based on the clock signal transmitted from the master node device 11. The time length T1 is, for example, 300 microseconds. In other words, the processor 122 determines whether the prescribed time length T1 has elapsed. The determination is repeated until the time length T1 elapses (NO in STEP2).

When it is determined that the prescribed transmission timing comes (YES in STEP2), the processor 122 starts transmitting the generated data (STEP3). The data is transmitted from the communication interface 111 to the network communication bus 2. FIG. 4 illustrates an example in which the slave node device A and the slave node device B transmit data in accordance with a request from the master node device. The slave node device A transmits the data D1. The slave node device B transmits the data D2.

As described above, since the time length T1 is the same for all the slave node devices 12 in the initial state, there may be a case where data transmission from a plurality of slave node devices 12 is initiated simultaneously. On the other hand, the master node device 11 can receive data in response to a certain transmission permitting signal P only from one of the slave node devices 12. Accordingly, an arbitration processing for determining a single set of data to be received by the master node device 11 is performed.

As described with reference to FIG. 2, relative priorities are assigned in advance to the slave node devices 12 connected to the network communication bus 2. The priorities are determined based on the urgency of the data to be transmitted, or the like. The priority information indicating the priority is included in the header region of the data to be transmitted. The priority information may be represented by at least one bit included in the header region. For example, when the bit is “0”, it is determined that the priority is higher than when the bit is “1”. In a case where the priority information is represented by a plurality of bits, comparison is performed between bits closer to the head of the bit string, and it is determined that the priority of the data associated with the bit string in which “1” appears earlier is lower.

In the example illustrated in FIG. 4, it is assumed that the priority of the slave node device A is set higher than the priority of the slave node device B. In this case, the priority information included in the header region of the data D1 and the priority information included in the header region of the data D2 are compared. As a result, the data D1 succeeds to be arbitrated, whereas the data D2 fails to be arbitrated. In this case, the transmission of the data region following the header region of the data D1 is continued. On the other hand, the transmission of the data D2 in the header region that has failed to be arbitrated is suspended.

Each slave node device 12 monitors the contents of the data actually transmitted to the network communication bus 2. When the data generated to be transmitted and the data actually transmitted are different from each other, the processor 122 determines that the transmission of the data has failed. In the case of the above example, the data D1 generated in the slave node device A matches the data D1 actually transmitted. On the other hand, since the transmission of the data D2 generated in the slave node device B is suspended, the generated data and the actually transmitted data are different from each other. Accordingly, the processor of the slave node device B determines that the transmission of the data D2 has failed.

As illustrated in FIG. 3, the processor 122 of each slave node device 12 determines whether the transmission of the data has failed as described above (STEP4). When it is determined that the transmission of the data is succeeded (NO in STEP4), the processing ends.

As illustrated in FIG. 4, the master node device 11 periodically outputs a transmission permitting signal P. The data for which the transmission is not completed is subjected to retransmission as a response to the next transmission permitting signal P. As illustrated in FIG. 3, when it is determined that the transmission of the data is failed (YES in STEP4), the processor 122 of the slave node device 12 performs a processing for advancing the retransmission timing of the data (STEP5). In other words, the time length from the time when the transmission permitting signal P is received until the time when the retransmission of the data is initiated is reduced from the initial value T1 to T2. The time length T2 is, for example, 200 microseconds.

Subsequently, the processor 122 determines whether the prescribed retransmission timing comes (STEP6). That is, the processor 122 determines whether the time length T2 has elapsed since the transmission permitting signal P was received by the communication interface 121. At this timing, it is also determined whether the transmission permitting signal P is received in the same manner as in STEP1, but the illustration is omitted. The determination is repeated until the time length T2 elapses (NO in STEP6).

When it is determined that the prescribed retransmission timing comes (YES in STEP6), the processor 122 starts retransmission of the data (STEP7). The data is transmitted from the communication interface 121 to the network communication bus 2. When the retransmission is completed, the processing ends.

Advantages of such a configuration will be described with reference to comparative examples illustrated in FIGS. 5 and 6. In the comparative example, the timing (i.e., the time length T1) at which the transmission of data is initiated in response to the transmission permitting signal P is unchanged. The relationship between the priority levels of the slave node device A and the slave node device B is the same as the example illustrated in FIG. 4.

As illustrated in FIG. 5, when the transmission permitting signal P transmitted from the master node device is received by the slave node device A and the slave node device B, the transmission of the data D1 and the transmission of the data D2 are simultaneously initiated after the elapse of the time length T1. As a result, the arbitration processing is performed based on the priorities set for the slave node device A and the slave node device B, and the transmission of the data D2 that has failed to be arbitrated is suspended. Accordingly, the data D2 is subjected to retransmission as a response to the transmission permitting signal P transmitted from the master node device next time. In the example illustrated in FIG. 3, only the slave node device B transmits data with respect to the next transmission permitting signal P, so that the arbitration processing is not performed. The transmission of the data D2 is completed without any problem.

FIG. 6 illustrates a case in which, the retransmission of the data D2 by the slave node device B as well as the transmission of the data D3 by the slave node device A are performed in response to the next transmission permitting signal P. Since the time length T1 from the reception of the transmission permitting signal P to the initiation of the data transmission is unchanged, the retransmission of the data D2 and the transmission of the data D3 are performed simultaneously. Accordingly, the arbitration processing is performed again between the data D2 and the data D3. Since the priorities of the slave node device A and the slave node device B do not change, the data D2 fails to be arbitrated and is subjected to the retransmission again. In this manner, data transmitted from a specific slave node device may continue to fail to be arbitrated, so that the reception of the data by the master node device may be delayed.

Each slave node device 12 is configured not to perform data transmission when another slave node device 12 has already initiated data transmission to the network communication bus 2. For example, when a state corresponding to the signal level “1” of the network communication bus 2 continues for a certain time length or longer, the transmission of data may be initiated. When communication is already initiated by another slave node device 12, such a state of the signal level cannot be obtained.

According to the configuration of the present embodiment, as illustrated in FIG. 4, since the timing of retransmission of data from the slave node device that has failed to transmit due to the arbitration failure is advanced, it is easy to avoid a situation in which data transmitted from a specific slave node device continues to fail to be arbitrated. Specifically, since the retransmission timing of the data D2 from the slave node device B is advanced, when the transmission timing of the data D3 from the slave node device A (unchanged from the initial state) comes, the retransmission of the data D2 from the slave node device B is already initiated. Accordingly, the transmission of the data D3 is not performed. The data D3 is subjected to retransmission as a response to a further subsequent transmission permitting signal P. Accordingly, it is possible to suppress a delay in the reception of data transmitted from a specific slave node device caused by the arbitration failure.

Each slave node device 12 does not change the priority information included in the header region of the data when performing the processing for advancing the retransmission timing. That is, a relationship relating to the priority among the slave node devices defined in advance is maintained. In the case of the example illustrated in FIG. 4, there is no change in the fact that the priority of the slave node device A is higher than the priority of the slave node device B. However, as far as the data D2 that has failed to be arbitrated is concerned, the priority of the slave node device B is temporally made higher than the priority of the slave node device A by advancing the retransmission timing.

According to such a configuration, since the processing for rewriting the priority information is unnecessary, it is possible to suppress an increase in the processing load of the processor 122 in the slave node device 12. In particular, in a configuration in which the priority information also serves as the identification information of the slave node device 12, it is possible to suppress an influence exerted on the identification processing.

FIG. 4 illustrates a conflict between data transmitted from two slave node devices 12. However, when more slave node devices 12 are connected to the network communication bus 2, an arbitration failure of data may occur in a plurality of slave node devices. In this case, a conflict occurs again between the data retransmitted by the slave node devices, and the arbitration processing is performed. For example, there may be a case where the data D2 to be retransmitted fails to be arbitrated again by the data D4 (not illustrated) transmitted from the slave node device C (not illustrated) to which a higher priority than the slave node device B is assigned.

In order to cope with such a situation, as illustrated by dashed lines in FIG. 3, the processor 122 of each slave node device 12 may perform processing for further advancing the retransmission timing every time the transmission of data fails. In the example illustrated in FIG. 4, when the data D2 fails to be arbitrated with respect to the data D4 and fails to be transmitted again (YES in STEP4), the processor 122 performs a processing for further advancing the timing at which the data D2 is retransmitted (STEP5). In other words, the time length from the next reception of the transmission permitting signal P to the initiation of the retransmission of the data is shortened from the current value T2 to T3 (not illustrated). The time length T3 is, for example, 100 microseconds.

As a result, it is possible to further reduce the probability that the data D2 fails to be arbitrated again when responding to the transmission permitting signal P transmitted from the master node device next time. Accordingly, it is possible to further suppress a delay in reception of data transmitted from a specific slave node device caused by an arbitration failure.

In the above example, each time certain data fails to be transmitted due to an arbitration failure, the time length defining the retransmission timing is reduced from 300 microseconds to 200 microseconds, and from 200 microseconds to 100 microseconds. That is, the amount of time required to advance the retransmission timing is 100 microseconds. However, the amount of time may be determined based on the time length T1 defining the initial transmission timing and the number of slave node devices 12 capable of transmitting data to the network communication bus 2 simultaneously.

For example, in a case where 10 slave node devices 12 can simultaneously transmit data to the network communication bus 2, the amount of time described above can be determined as a value capable of shortening the time length from the reception of the transmission permitting signal P to the initiation of the data retransmission by 10 steps from the initial time length T1. According to such a configuration, the data transmitted from a specific slave node device 12 does not continue to fail to be arbitrated until the end. At this time, it is not necessary that the number of slave node devices 12 capable of simultaneously transmitting data to the network communication bus 2 matches the number of steps capable of shortening the time length until the initiation of retransmission. By increasing the number of steps capable of shortening the time length until the initiation of retransmission within a range no less than the number of slave node devices 12 capable of simultaneously transmitting data to the network communication bus 2, it is possible to reduce the possibility that the data transmitted from a specific slave node device 12 will continue to fail to be arbitrated.

It should be noted that the amount of time for which the retransmission timing is advanced is determined to be longer than the time required for transmitting one bit of data on the network communication bus 2. In the case of the above example, the time required for transmitting one bit of data is determined based on the clock frequency transmitted from the master node device 11. According to such a configuration, it is possible to reliably perform retransmission of the data that has failed to be arbitrated.

The above embodiments are merely illustrative for facilitating understanding of the presently disclosed subject matter. The configuration according to the above embodiment can be appropriately modified or improved without departing from the gist of the presently disclosed subject matter.

In the above embodiment, the communication network 3 is operated based on the CXPI standard of the polling system, and the plurality of node devices 1 connected to the network communication bus 2 include the master node device 11 and the slave node device 12. However, the above-described processing of advancing the timing of retransmission of data that has failed to be transmitted can be applied to a communication network in which there is no distinction between a master and a slave with respect to a plurality of node devices 1. Examples of the communication network include a communication network operating based on a CAN (Control Area Network) standard of a carrier sense scheme. The cause of the data transmission failure is not limited to the arbitration failure. Due to the occupation of the network communication bus by the data transmission of another node device, there may be a case where the data transmission cannot be performed at a prescribed timing. Such a situation is also an example of the data transmission failure.

The present application is based on Japanese Patent Application No. 2019-089689 filed on May 10, 2019, the entire contents of which are incorporated herein by reference.

1. A node device adapted to be connected to a network communication bus, comprising:
a communication interface; and
a processor configured to cause the communication interface to transmit data to the network communication bus,
wherein in a case where the processor fails to transmit the data, the processor is configured to advance a retransmission timing at which the data is retransmitted.

2. The node device according to claim 1,
wherein priority information indicating a priority level of the data is assigned to the data; and
wherein the processor is configured to advance the retransmission timing without changing the priority information.

3. The node device according to claim 1,
wherein the processor is configured to further advance the retransmission timing each time the processor fails to transmit the data.

4. The node device according to claim 1,
wherein an amount of time for advancing the retransmission timing is determined based on the number of node devices capable of transmitting data to the network communication bus simultaneously.

5. The node device according to claim 1,
wherein an amount of time for advancing the retransmission timing is determined so as to be longer than an amount of time required for transmitting one bit of data on the network communication bus.

6. The node device according to claim 1,
wherein the retransmission timing is determined based on a time length elapsed from when a signal permitting the node devices connected to the network communication bus to transmit the data is received by the communication interface.
